(19) United States
(12) Patent Application Publication
(10) Pub. No.: US 2007/0026207 A1
(43) Pub. Date: Feb. 1, 2007

(54) System and method for custom-designing a printed article

(76) Inventor: Kristina Elizabeth Wrenn, New York, NY (US)

Correspondence Address: KENYON & KENYON LLP, 1500 K STREET N.W., SUITE 700, WASHINGTON, DC, 20005, US

(21) Appl. No.: 11/432,979

(22) Filed: May 11, 2006

Related U.S. Application Data
(60) Provisional application No. 60/680,485, filed on May 13, 2005.

(51) Int. Cl. B44C 1/17

(52) U.S. Cl. 428/195.1

(57) ABSTRACT

A system for custom designing a printed article assembly including a design guide that sequentially depicts a plurality of design options for a different one of a plurality of design parameters. The design guide directs the serial selection of at least one of the plurality of design options for each of the plurality of design parameters. The system also includes a collection of sample printed article assemblies that acts as a cross-reference for the design guide and exemplifies various combinations of the plurality of design options depicted in the design guide to assist in the decision making involved in the design process. A method of custom designing a printed article assembly is also provided.

### CROSS-REFERENCE TO RELATED APPLICATIONS

The present application claims priority to U.S. Provisional Application No. 60/680,485, filed May 13, 2005, which is incorporated by reference herein.

### FIELD OF THE INVENTION

The present invention is directed to a system and method for custom-designing a printed article assembly.

### BACKGROUND OF THE INVENTION

Articles having surface design features, such as invitations for example, have been provided to consumers and retailers using on-demand production facilities where the consumer or retailer can select from different colors and patterns and then have their desired arrangement printed on-demand. Presently available systems, however, only allow customers to change a few design parameters such as paper color, printing process, font, and ink color and provide a limited number of options for each design parameter. Other systems are structured to only offer sample invitations and allow a few changes to be made within one sample invitation. For example, such systems provide sample books that are structured to offer pre-designed samples with limited design parameters that may be altered within those pre-designed samples.

Some systems present a catalog of pre-designed invitations according to pre-determined themes and provide few design choices for limited alterations within each pre-designed invitation. These design choices include a restricted number of colors or colored envelopes. Other current systems, such as retail albums, allow customers, at most, to change the copy of a pre-designed invitation and to choose among two or three paper colors, two or three printing processes, eight to ten ink colors, and a limited number of text fonts. Some systems allow the adding of a motif or monogram and others also allow lining of a stock envelope in limited color options.

Present systems also offer response cards, thank you notes, and other related articles that correspond to a particular pre-designed invitation. For example, some systems provide one or two menu styles that correspond to a particular invitation style. Others, which provide a set of pre-designed articles in a wedding event suite, involve pairing a pre-designed wedding invitation with a matching envelope, response card, reception card, response envelope and thank you note. As such, the customer is given little creative control over the design of the event suite.

Accordingly, there is a need in the art for a design system that provides the customer with more creative control in designing a printed article.

### SUMMARY OF THE INVENTION

In an embodiment, the present invention provides a system for designing a custom printed article assembly comprising a design guide comprising sequential sections, each of the sequential sections depicting a plurality of prescribed design options for a different one of a plurality of design parameters. The design guide directs the serial selection of at least one of the plurality of design options for each of the plurality of design parameters for designing a complete custom printed article assembly. The system further comprises a collection of sample printed article assemblies, each of the sample printed article assemblies exemplifying various combinations of the plurality of design options for the plurality of design parameters.

In another embodiment, the present invention provides a method of designing a custom printed article assembly. The method comprises sequentially selecting at least one of a plurality of design options for each of a plurality of design parameters. The method further comprises consulting a collection of sample printed article assemblies exemplifying various combinations of the plurality of design options for the plurality of design parameters.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an embodiment of a sequential section of a design guide according to the present invention.

FIG. 2 is an embodiment of a sequential section of a design guide according to the present invention.

FIG. 3 is an embodiment of a sequential section of a design guide according to the present invention.

FIG. 4 and 4A is an embodiment of a sequential section of a design guide according to the present invention.

FIG. 5 is an embodiment of a sequential section of a design guide according to the present invention.

FIG. 6 is an embodiment of a sequential section of a design guide according to the present invention.

FIG. 7 and 7A is an embodiment of a sequential section of a design guide according to the present invention.

FIG. 8, 8A, 8B and 8C is an embodiment of a sequential section of a design guide according to the present invention.

FIG. 9 is an embodiment of a sequential section of a design guide according to the present invention.

FIG. 10 is an embodiment of a sequential section of a design guide according to the present invention.

FIG. 11 is an embodiment of a sequential section of a design guide according to the present invention.

FIG. 12, 12A and 12B is an embodiment of a sequential section of a design guide according to the present invention.

FIG. 13 is an embodiment of a sample printed article assembly of a collection of sample printed article assemblies according to the present invention.

FIG. 14 illustrates a collection of sample printed article assemblies and design guide assembled in a binder according to an embodiment of the present invention.

FIG. 15 is a flow chart depicting an order of selecting design parameters according to an embodiment of the present invention.

FIG. 16 is an embodiment of an order form according to the present invention.

FIG. 17 depicts a sketch sheet according to an embodiment of the present invention

FIG. 18 is an embodiment of a color swatch according to the present invention.

FIG. 19 is an embodiment of a card to which the color swatch of FIG. 18 can be attached according to the present invention.

### DETAILED DESCRIPTION OF THE INVENTION

In an embodiment, the present invention provides a system for designing a custom printed article assembly. Such a printed article assembly includes a printed article and accompanying components. Non-limiting examples of printed articles include invitations, menus, greeting cards, holiday cards, escort cards, place cards, save-the-date cards, enclosure cards, business cards, stationery, other types of announcements, tags, booklets, pamphlets, programs, and itineraries. Non-limiting examples of accompanying components include envelope, liners and accessories. The system, according to the present invention, comprises a design guide comprising sequential sections. Each sequential section depicts (illustrates and/or lists) a plurality of design options for a different one of a plurality of design parameters. The system, by its mere arrangement of sequential sections, directs a consumer (either the end customer and/or retailer) to select at least one of the plurality of design options for each of the plurality of design parameters resulting in the design of a complete custom-printed article assembly. Non-limiting examples of design parameters include configuration of the printed article, color of the stock material from which the printed article assembly is manufactured, stock material from which the printed article assembly is manufactured, process by which characters are printed on the printed article assembly, color of ink used to print the characters on the printed article assembly, character font for the printed article assembly, layout of the printed article, configuration of the envelope in which the printed article can be inserted, accessories and treatments accompanying the printed article or performed on the printed article, and any combinations thereof.

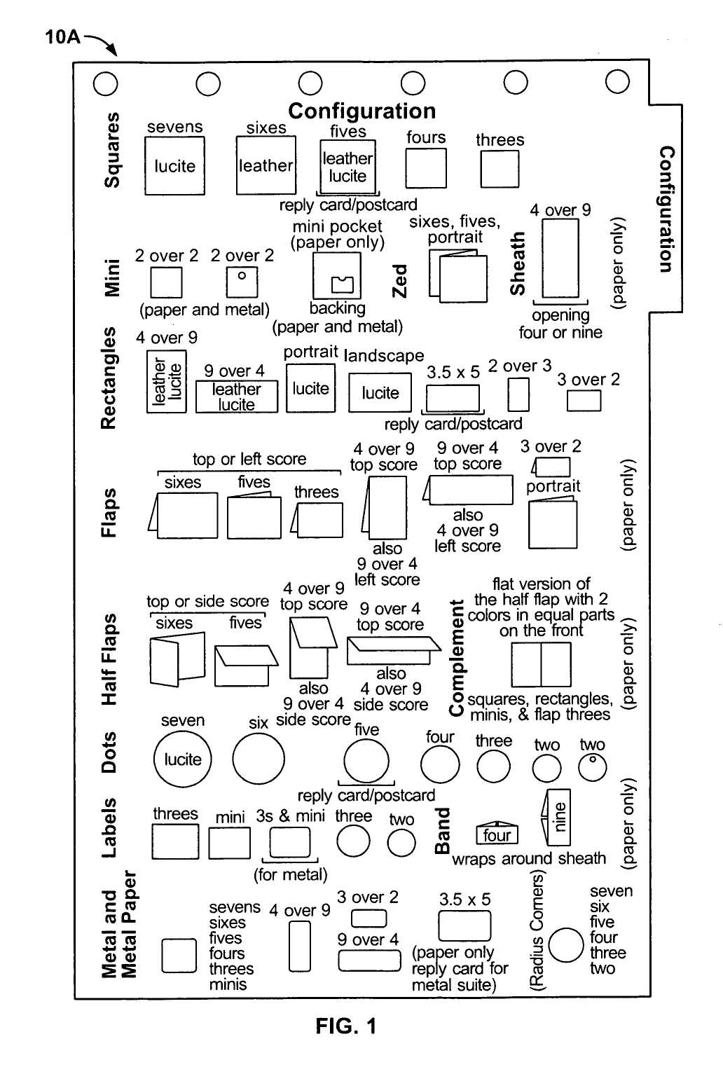

For example, referring to FIG. 1, a first section 10A of the design guide may depict a plurality of configuration options such as different shapes, sizes, orientations, and assemblies for the printed article. Non-limiting examples of configurations that can be depicted by first section 10A include squares, rectangles, circles, triangles and multi-sided two-dimensional configurations. Sheets may be depicted by first section 10A as being folded to illustrate multiple sides formed from a single sheet. Sheets of the same or different shapes may be depicted as being attached to one another, compiled, bundled, sheathed, nested, and/or interfolded. Edges of sheets may be depicted as rounded, cropped, feathered, folded, deckeled, edged or any combination thereof. Of course, the above-mentioned configuration options are only exemplary and additional or alternative types of configuration options may also be depicted by first section 10A.

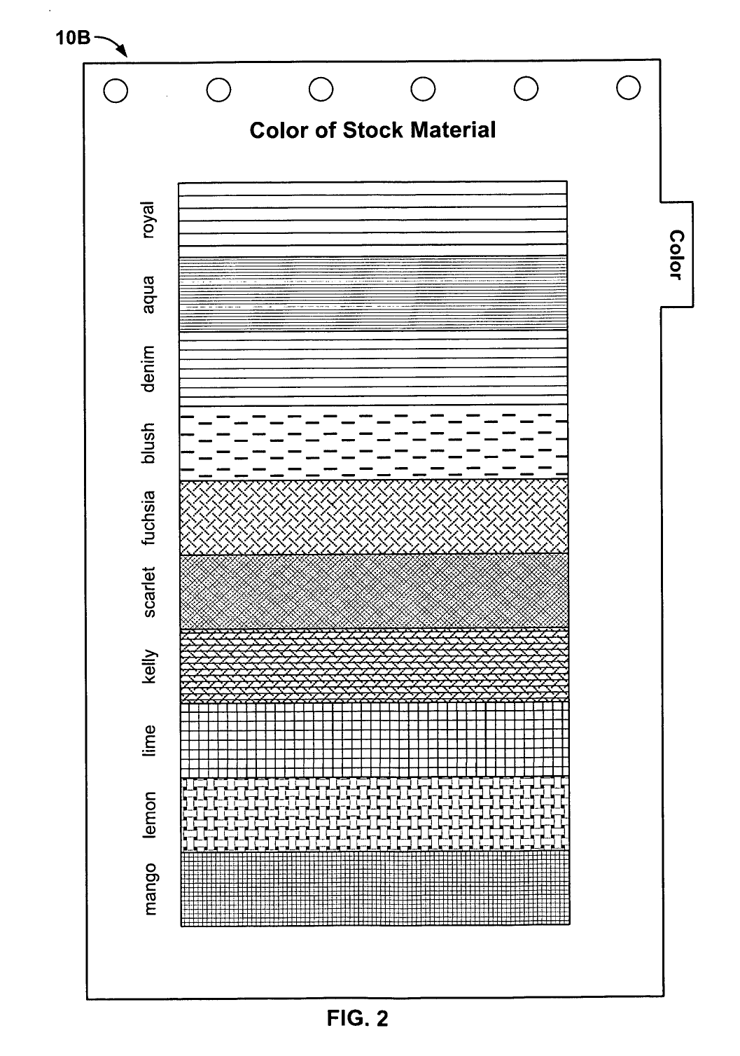

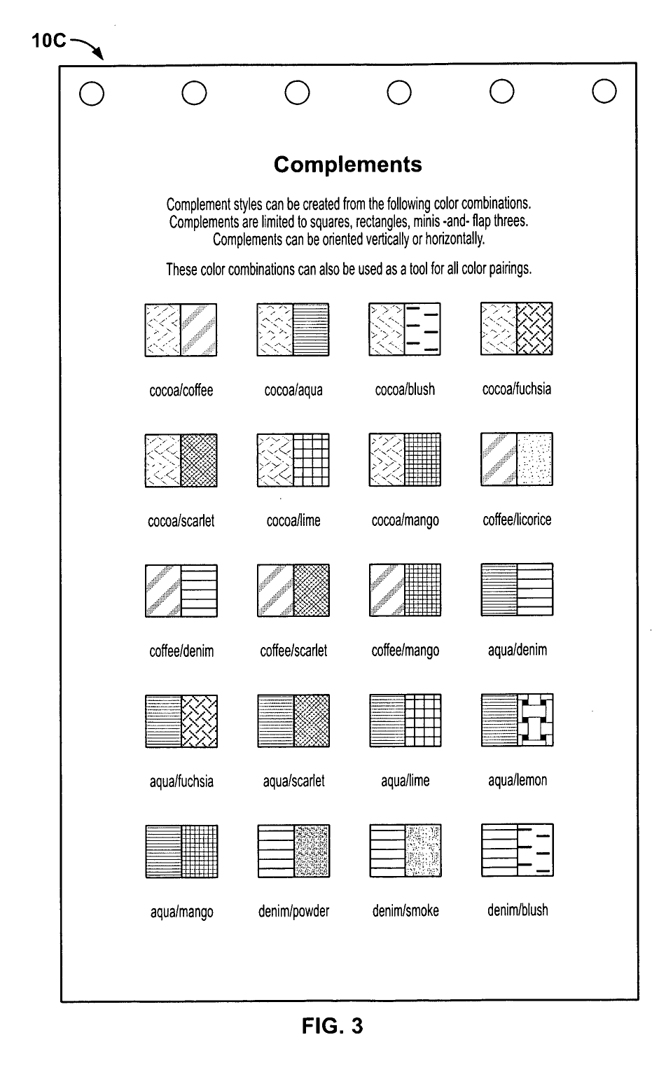

Referring to FIG. 2, another exemplary sequential section of the design guide preferably after first section 10A is second section 10B, which may depict a plurality of color options for the stock material of the printed article assembly, specifically color options for the printed article, envelope, liner, and/or accessories. Preferably, the plurality of color options depicted includes at least 10 different color options, more preferably at least 20 different color options, and even more preferably at least 50 different color options and any combinations thereof.

Referring to FIG. 3, another exemplary sequential section of the design guide preferably after second section 10B is third section 10C, which may depict a plurality of complementing color options for the printed article assembly. The complementing color options illustrate different color combinations to aid in designing the color scheme of the printed article and accompanying components. The complementary color options may be used for combinations of any two or more design parameters for the printed article assembly. For example, the complementary color options may be used for stock material color/ink color selections, envelope color/liner color selections, stock material color/envelope color selections and/or combinations of complementary colors on a single surface.

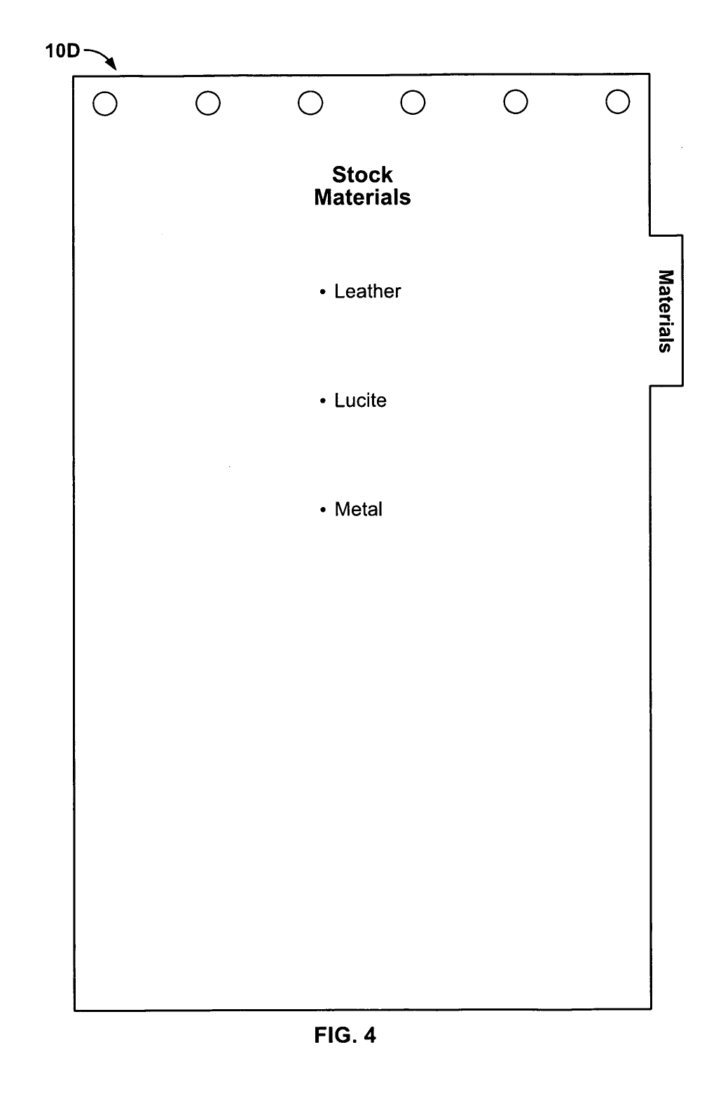

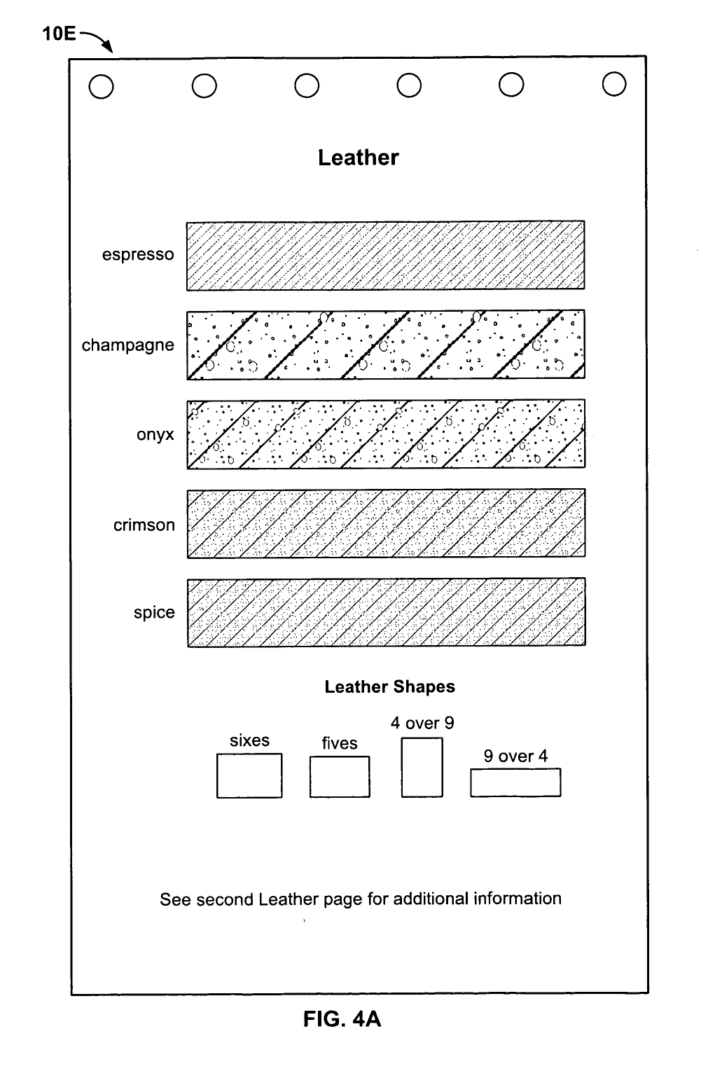

Referring to FIG. 4, another exemplary sequential section of the design guide preferably after third section 10C is fourth section 10D, which may depict a plurality of stock materials from which the printed article assembly may be manufactured, specifically stock materials for the printed article, envelope, liner, and/or accessories. Non-limiting examples of stock materials that may be depicted include paper, lucite, metal, leather, and vellum. As seen from FIG. 4, the stock materials need not be specifically illustrated in fourth section 10D, but simply may be listed. Alternatively or in addition, examples of types and color of the stock materials may be illustrated in the same section or in a sequential section to provide the consumer with a visual manifestation of the stock materials. For example, as shown in FIG. 4A, an additional sequential section 10E is provided, preferably after fourth section 10D, to further illustrate the stock material of leather.

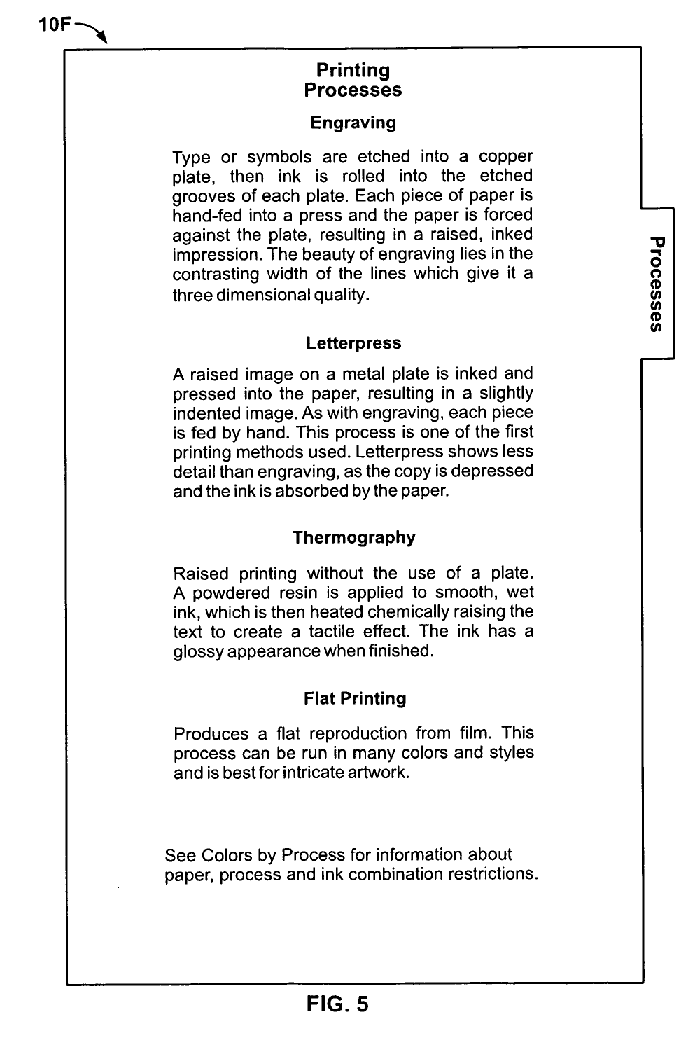

Referring to FIG. 5, another exemplary sequential section preferably after fourth section 10D/10E, is fifth section 10F, which may depict a plurality of printing processes by which the characters of the printed article assembly are printed. Non-limiting examples of printing processes are engraving, letterpress, thermography, and flat printing. Fifth section 10E may either illustrate examples of the characters printed by the particular processes, simply list the printed processes, or, as shown in FIG. 5, describe the printing processes.

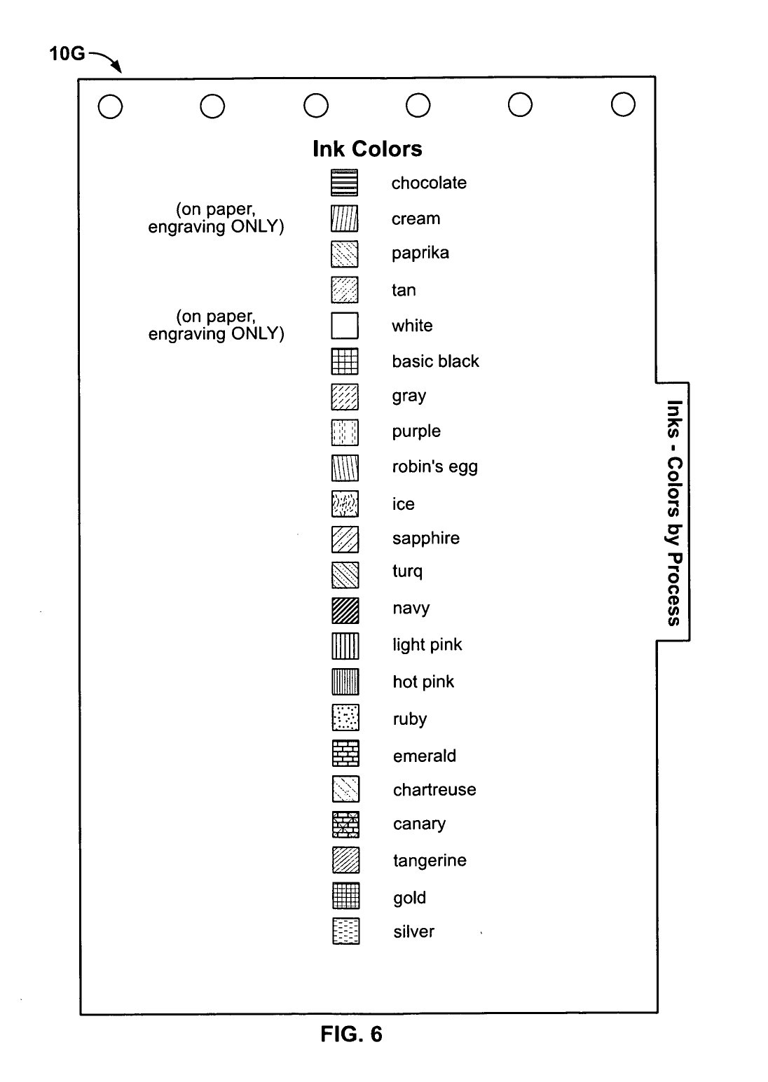

Referring to FIG. 6, another exemplary sequential section of the design guide preferably after fifth section 10F is sixth section 10G, which may depict a plurality of ink colors in which the characters of the printed article assembly may be printed. Preferably, the plurality of ink color options depicted includes at least 10 different ink color options and more preferably at least 20 different ink color options.

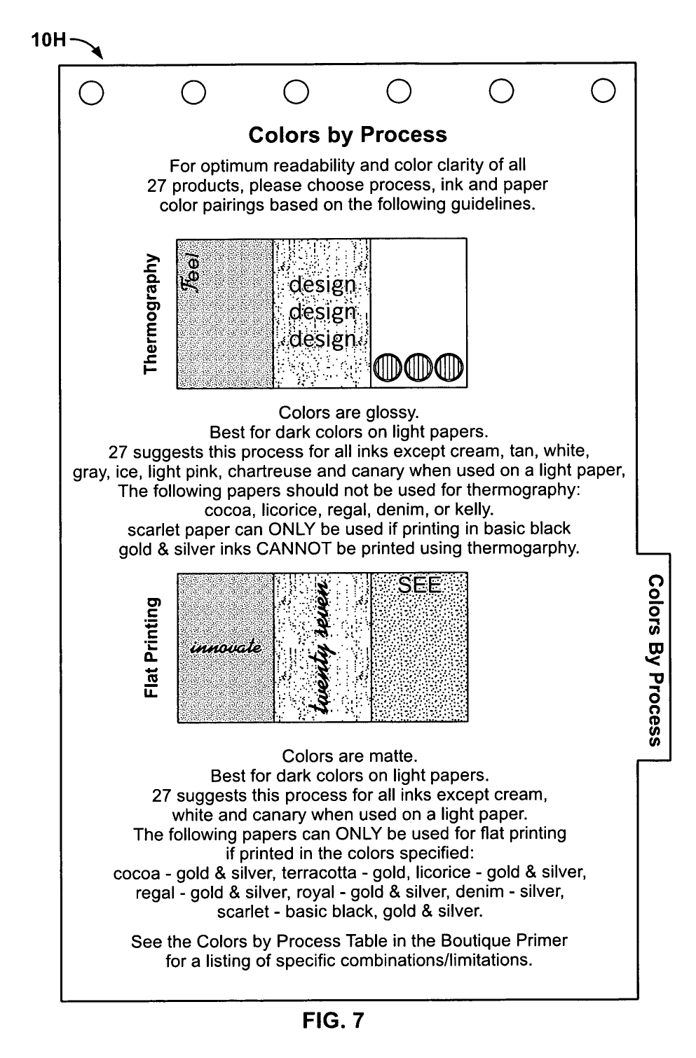

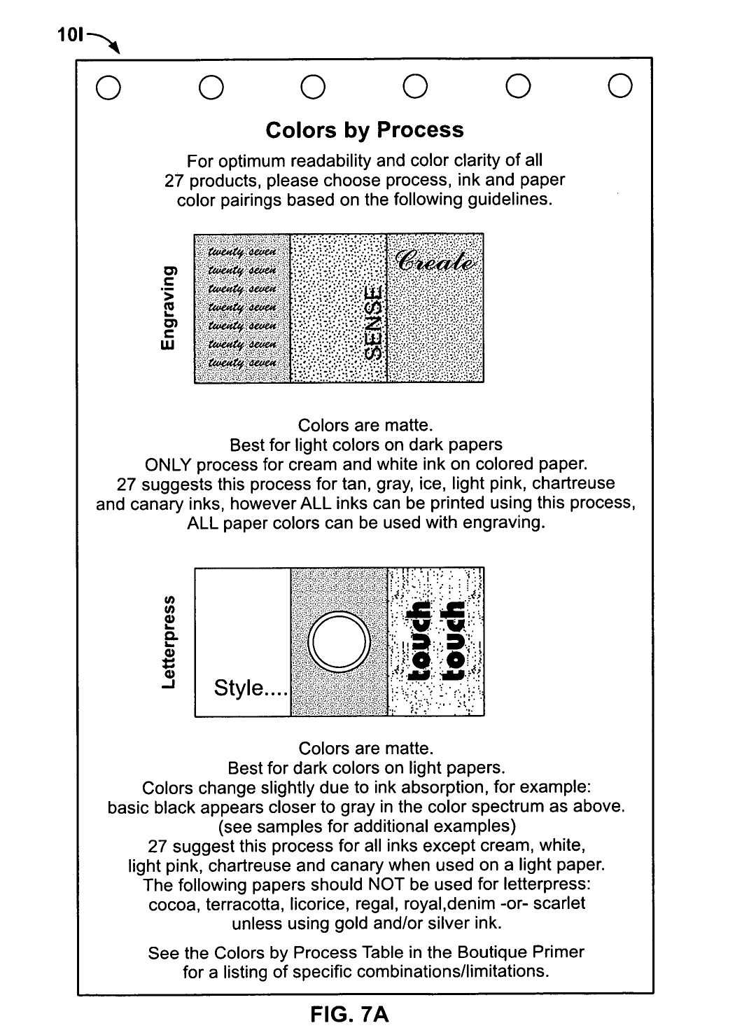

Referring to FIG. 7, another exemplary sequential section preferably after sixth section 10G is seventh section 10H, which may depict a plurality of options resulting from the selection of a combination of a prescribed printing process, selected from a plurality of prescribed printing processes, a prescribed paper color, selected from a plurality of prescribed paper colors, and a prescribed ink, selected from a plurality of prescribed inks, along with a prescribed font, selected from a plurality of prescribed fonts. Alternatively or in addition, examples of types of combinations of printing process, color, ink and font may be illustrated in the same section or in a sequential section. For example, as shown in FIG. 7A, an additional sequential section 101 is provided, preferably after seventh section 10H, to further illustrate a plurality of options.

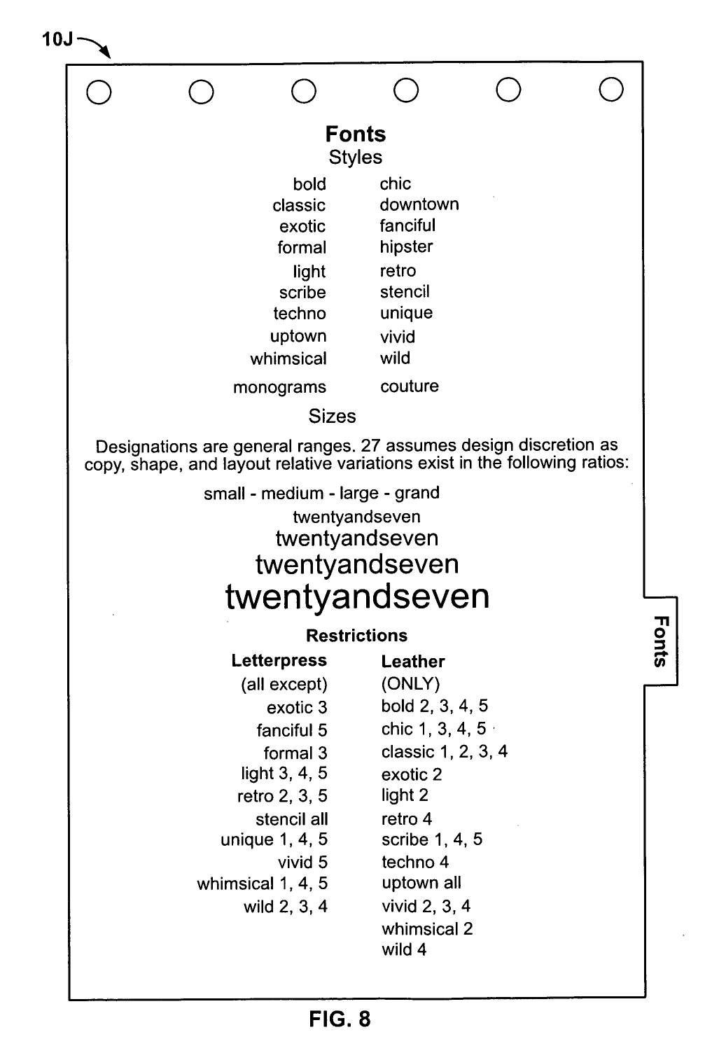

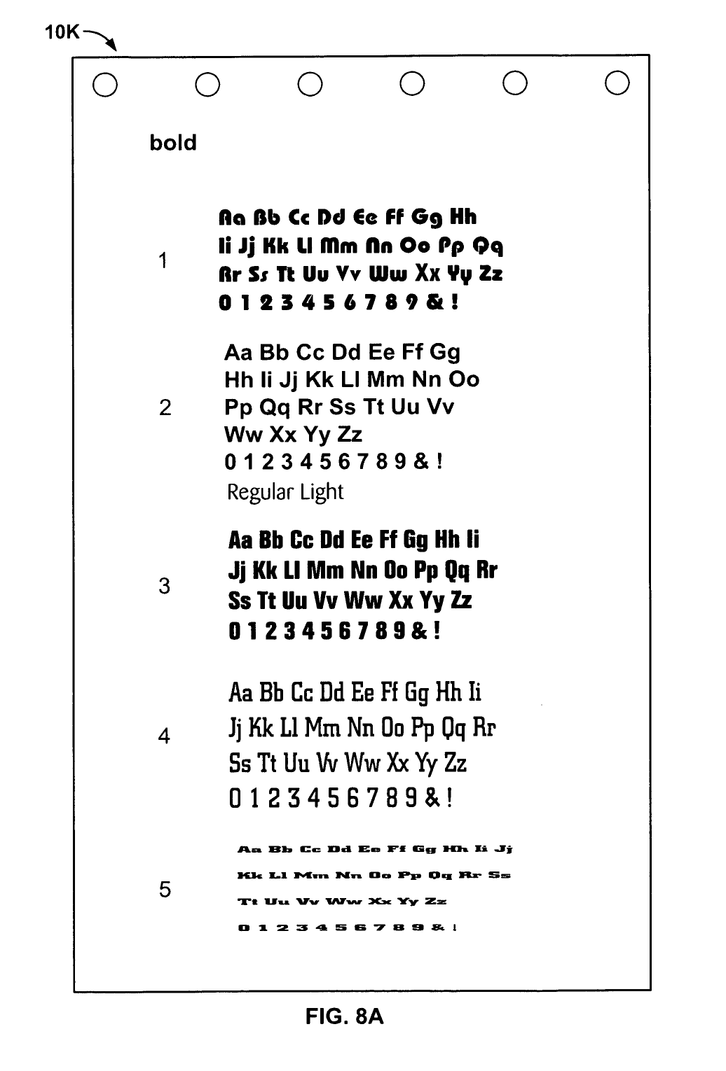

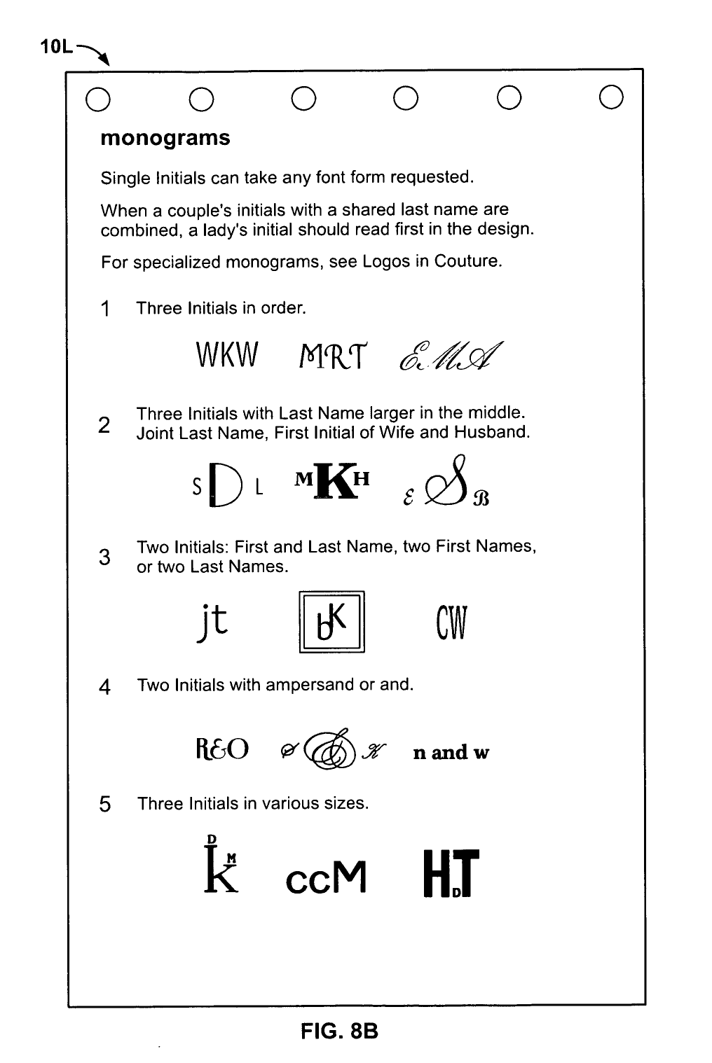

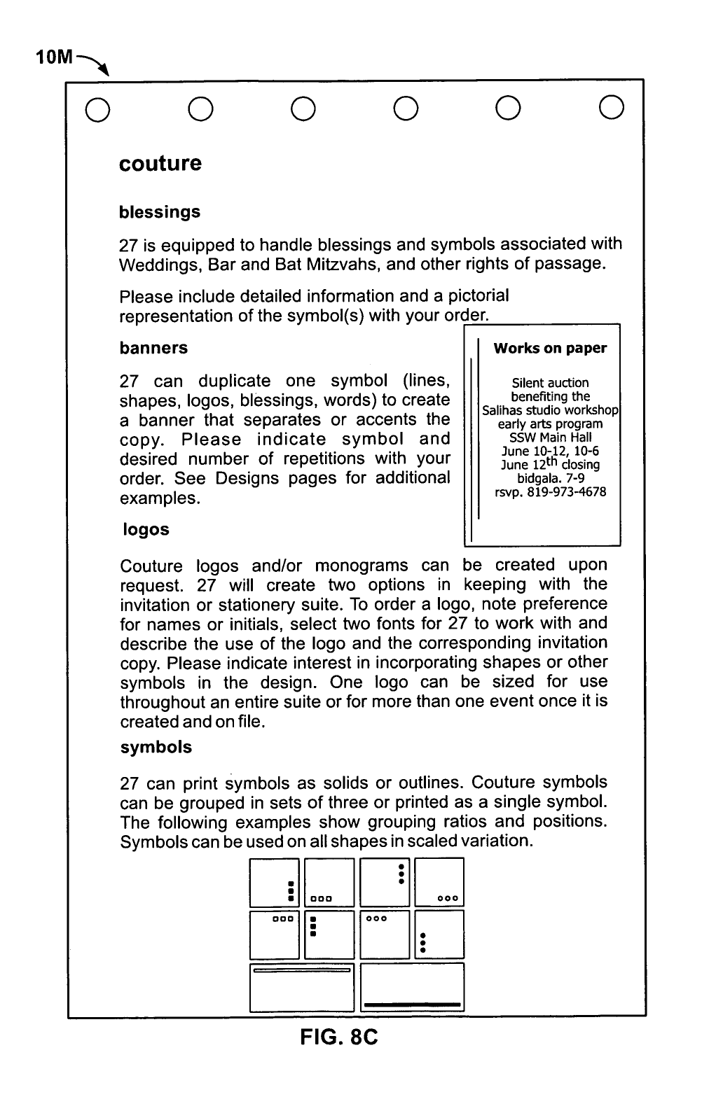

Referring to FIG. 8, another exemplary sequential section preferably after seventh section 10H/10I is eighth section 10J, which may depict a plurality of font options in which the characters of the printed article assembly may be printed. As seen from FIG. 8, the font options need not be specifically illustrated in seventh section 10J, but simply may be listed. Alternatively or in addition, examples of types of fonts may be illustrated in the same section or in a sequential section to provide the consumer with a visual manifestation of the type of fonts. For example, as shown in FIG. 8A, an additional sequential section 10K is provided, preferably after seventh section 10J, to further illustrate a specific type of font. Preferably, the plurality of font options depicted include at least 10 different font options, more preferably at least 50 different font options, and even more preferably at least 90 different font options. Eighth section 10J may also depict different sizes of fonts, such as small, medium, large, and grand. Referring to FIG. 8B, an additional sequential section 10L may be provided that depicts monograms and, referring to FIG. 8C, yet another sequential section 10M may be provided that depicts and/or describes use of blessings, symbols, banners and logos.

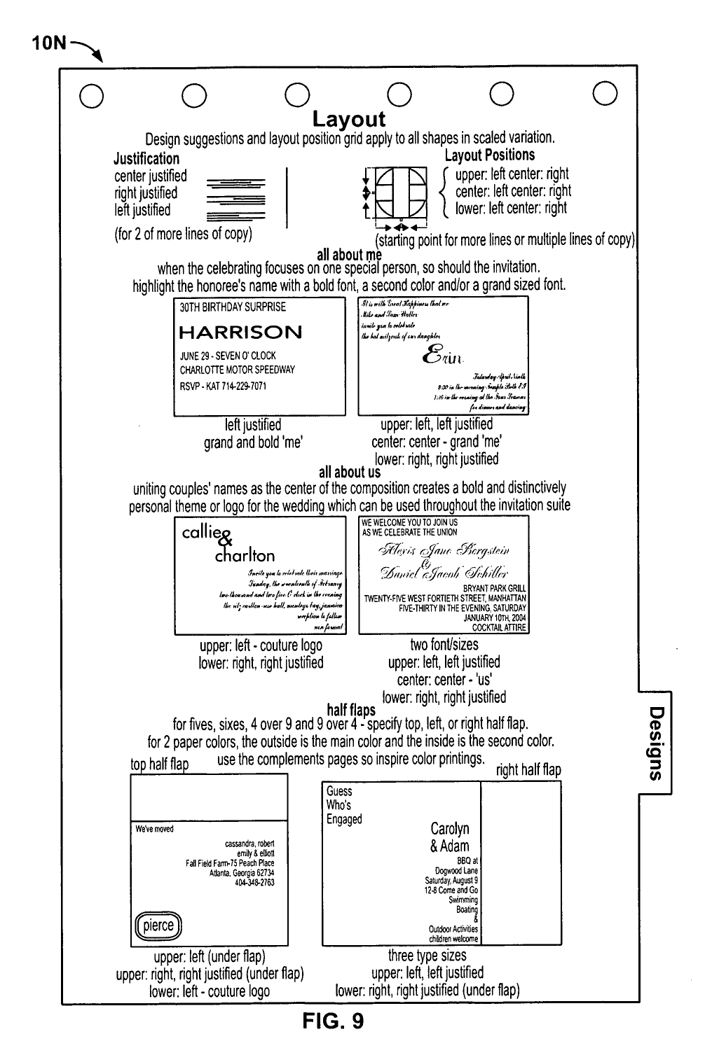

Referring to FIG. 9, another exemplary sequential section preferably after eighth section 10J, 10K, 10L, and/or 10M, is ninth section 10N, which may depict a plurality of layout options in which the characters of the printed article assembly may be arranged. Non-limiting examples of layout options that may be depicted include a plurality of justifications for type-setting such as center, right, left, top, bottom and spread. Other types of layout options that may be depicted include a variety of positions of text on a sheet, in which positions may be identified with the use of positions in a grid, such as upper-left, bottom-center, or center. Positions may also be identified with polar coordinates, clock positions, or angles or identified with sketches done free-hand on sketch sheets, which may be additionally provided by the system of the present invention and which are described in more detail below. Other layout options that may be depicted include layout options illustrating key words placed in the center of a sheet, printed as the largest letters on a sheet, printed in bold or contrasting colors on a sheet, or printed in a singular font on a sheet. Such layout options provide the consumer with the option of focusing the viewer's attention on specific text. Additional layout options depicted by ninth section 10N may include characters printed to form a particular shape, such as characters printed to form a circle, and multiple words, shapes or pictures that are placed in opposing orientations such as perpendicular or upside down for aesthetic effect or emphasis. Of course, the above-mentioned layout options are only exemplary and additional or alternative layout options may be depicted by ninth section 10N.

Ninth section 10N may also depict layout options such as two-sided designs that can be created by simply following the steps outlined in the sequential sections of the design guide twice or in the case of designing a printed article with multiple sheets, as many times as required to design all sheets.

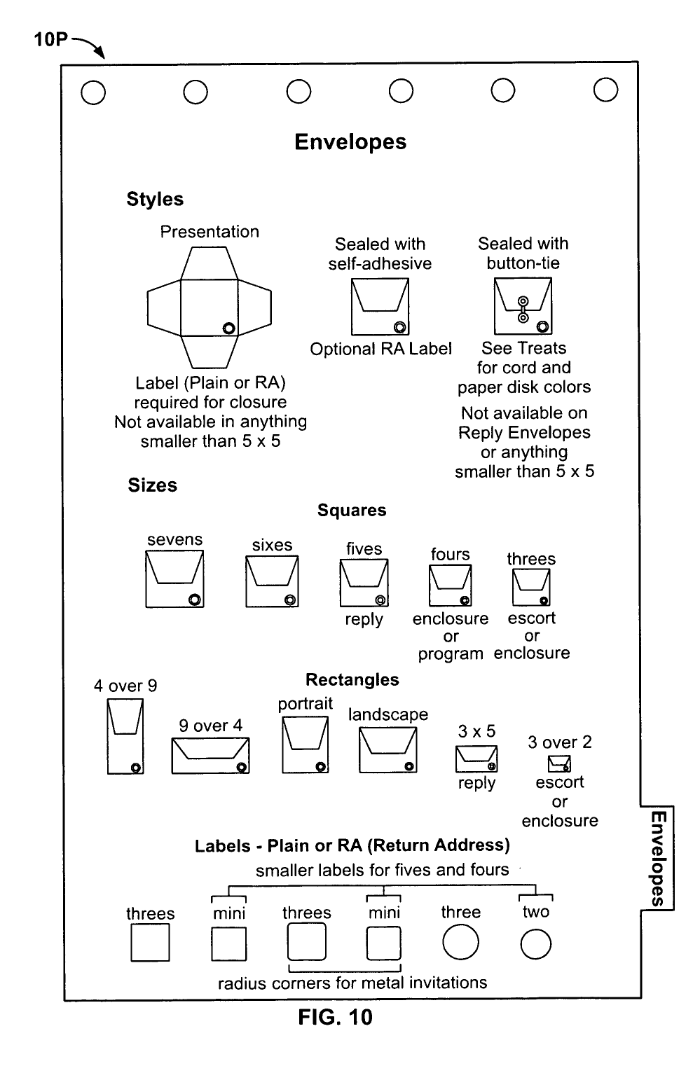

Referring to FIG. 10, another exemplary sequential section preferably after ninth section 10N is tenth section 10P, which may depict a plurality of options for the configuration of the envelope in which the printed article can be contained or in which a reply card can be contained. Envelope configuration options include different shape, assembly, size, and orientation options for the envelope. Non-limiting examples of envelope configuration that may be depicted by tenth section 10P is envelopes of different sizes and shapes and different types of envelope closures such as envelopes sealed with self-adhesive, envelopes sealed with ribbons, envelopes sealed with buttons, and envelopes sealed with discs tied together with cord.

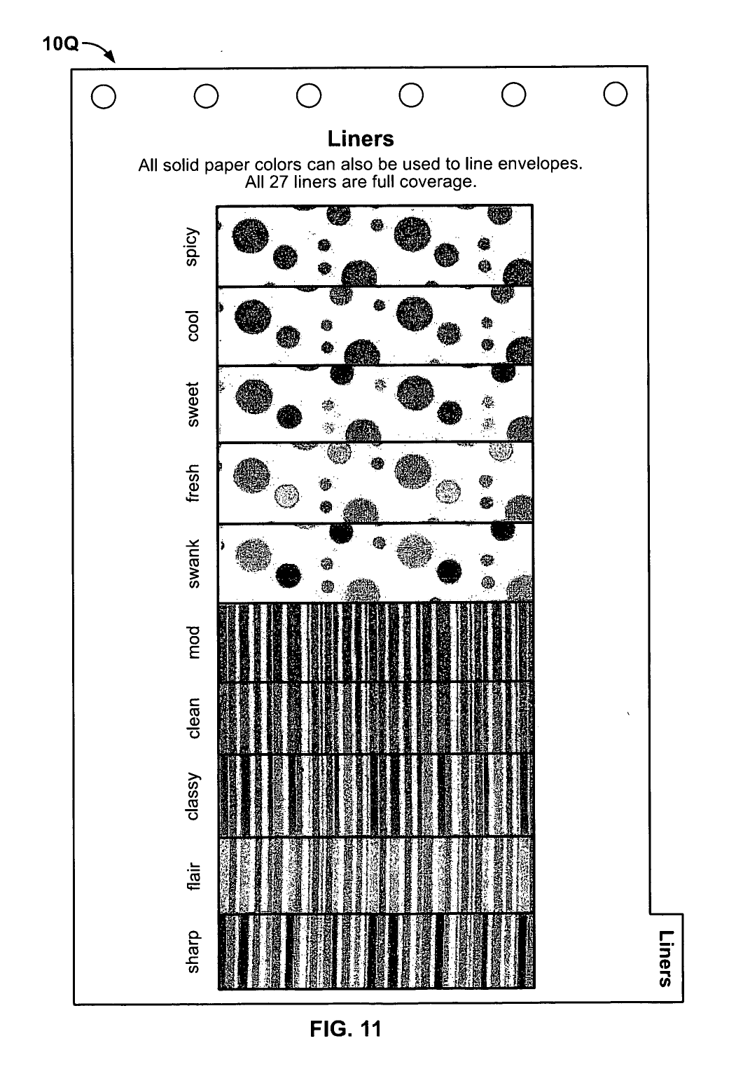

Referring to FIG. 11, another exemplary sequential section preferably after tenth section 10P is eleventh section 10Q, which may depict a plurality of options for the configuration, color scheme and pattern of the envelope liner. Liners can be full coverage. Patterns may include, for example, stripes, polka dots, objects, symbols, monograms and text. The sequential section can also provide instructions as to what other stock materials and colors may be provided as liners.

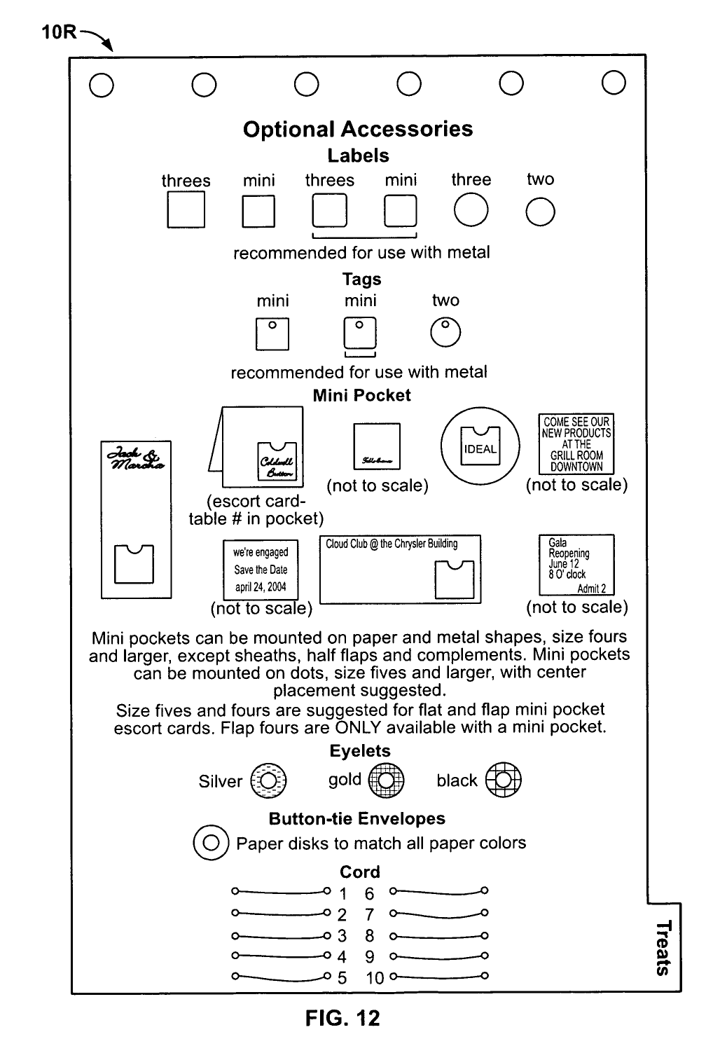

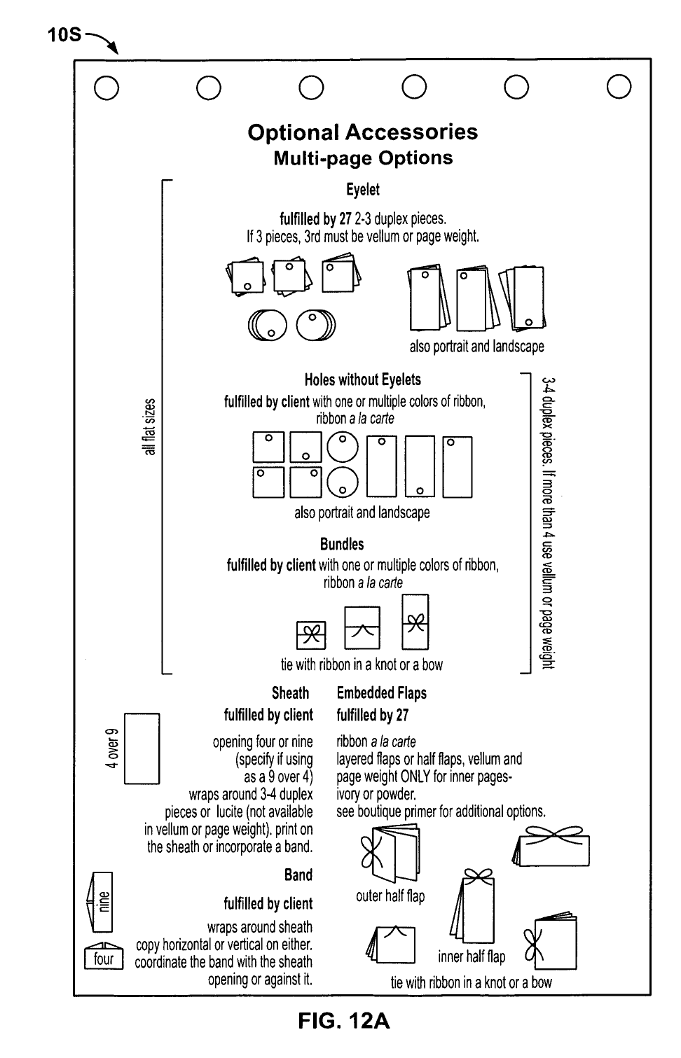

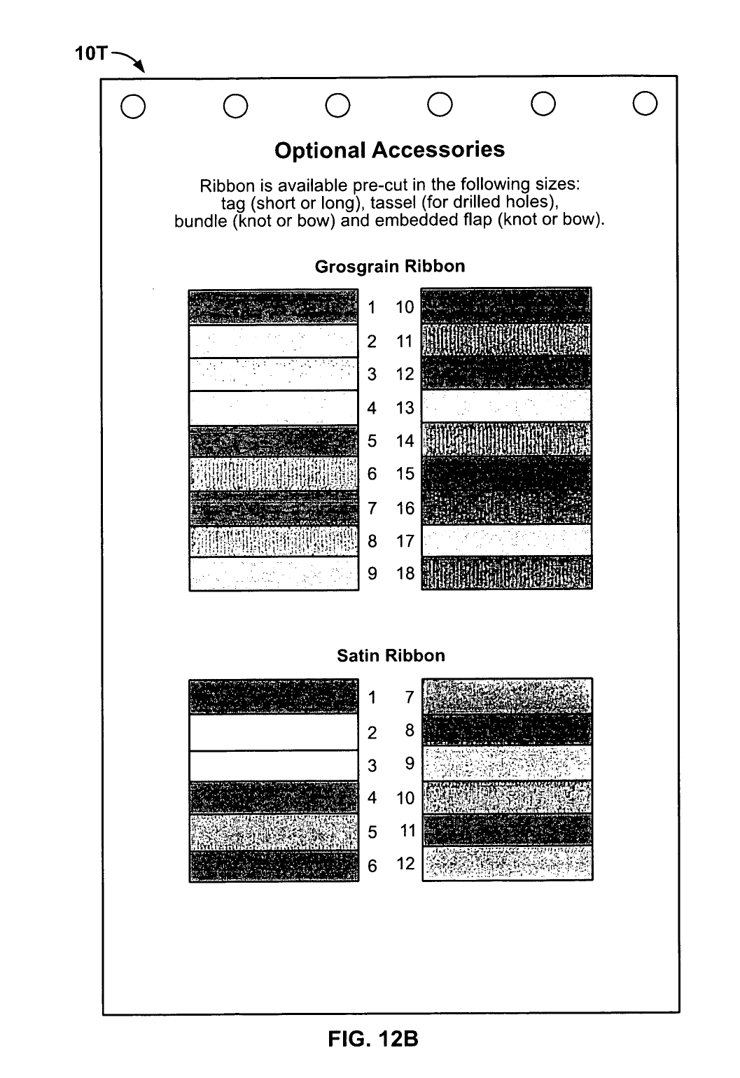

Referring to FIG. 12, another exemplary sequential section preferably after eleventh section 10Q is twelfth section 10R, which may depict a plurality of optional accessory and treatment options to accompany or modify the printed article assembly. Non-limiting examples of optional accessory and treatment options that may be depicted include liners, with full coverage or tipped-in or any other style, labels, pockets, eyelets, holes without eyelets, button-ties, cords, ribbons, other trinkets, bands, sheaths, bound printed articles, bundled printed articles, and printed articles assembled as flaps, as depicted in additional sequential section 10S. Non-limiting examples of ribbons that may be depicted include grosgrain and single or double-faced satin or other styles, as depicted in additional sequential section 10T. Accessories may be attached to any printed article depending on the preference of the consumer and may be limited to particular positions on a printed article for reasons of aesthetics or production. Pockets and other added attachment members such as eyelets, cords, ribbons, and bands may be used to hold or bind multiple-sheet printed articles or simply for aesthetic effect. Other accessories may be depicted that provide added color or to attach ancillary texts, symbols or pictures. Treatments that may be depicted include sheets having portions removed to create a hole or cut-out of a chosen shape or design.

The above-described sections of the design guide are only exemplary and are not intended to be exclusive or exhaustive. Other sections depicting other design parameters and other prescribed design options may also be utilized in the system of the present invention. Further, although it is preferable that the sequential sections of the design guide are provided in the specific sequence described above, variations of this specific sequence are also contemplated by the present invention so much as such variations provide a logical and practical sequence. Moreover, any of two or more of above-described sections could be combined into a single section. In addition, any particular section that depicts particular design options for a particular design parameter, may also depict relevant other design options of another design parameter that apply to the particular design option depicted in the respective section. Specifically, specific types of stock materials may only be able to be manufactured in specific types of configurations and such configurations may be depicted with the sequential section depicting such specific type of stock material. For example, as shown in FIG. 4A, section 10E depicts the stock material of leather as well as the specific shapes and sizes in which the leather can be manufactured. Moreover, preferably the design options and design parameters are provided as user-friendly names such as “dots” for circles and “treats” for accessories and treatments accompanying the printed article or modifications that can be made thereto, although such terms are not explicitly used herein.

The system of the present invention preferably provides limitations and/or recommendations regarding the combination of certain ones of the plurality of design options with other ones of the plurality of design options. For example, certain combinations of design options are prohibited and certain design options are limited to being used with only certain other design options. In addition, certain design options are optimally suited to be paired with certain other design options. Such limitations and/or recommendations can be provided by the design guide and/or a separate reference manual (described below) that can be part of the system of the present invention. In a preferred embodiment all information from the design guide, including limitations and recommendations, is contained in the reference manual along with additional information that may be helpful to the consumer. Alternatively, the limitations and recommendations can be partially provided by the design guide and partially provided by the reference manual or all information may be partially provided by the design guide and partially provided by the reference manual.

For example, the system can recommend which shapes and sizes should be presented together, prohibit certain shapes and sizes from being placed together (because of limiting parameters in the printing or binding process, for example) and suggest complementary color schemes. Other limitations and recommendations may be provided with respect to the use of certain materials in certain portions of the printed article. For example, the system can provide a restriction on vellum, as a stock material, whereby vellum cannot be adhered to any other stock material. The system may also suggest use of certain ink colors in particular printing processes and/or particular stock materials, such as engraving with tan or gray ink or using dark ink colors on light papers for letterpress printing; may restrict the printing of certain ink colors on certain stock materials, such as limiting printing on leather to particular ink colors or suggesting thermography for stand-alone metal with paper; may restrict certain combinations of colors, such as by prohibiting the printing of licorice ink on a basic black background; may restrict use of accessories for certain configurations of the printed article assembly, such as by restricting use of pockets for certain configurations of the printed article (for example, requiring that pockets for multiple-folded sheets be mounted on the front or specified inside surfaces of a printed article); and may recommend using dark colors on light paper. Of course the above-described limitations and recommendations are only exemplary and additional or alternative limitations and recommendations can be provided by the system of the present invention.

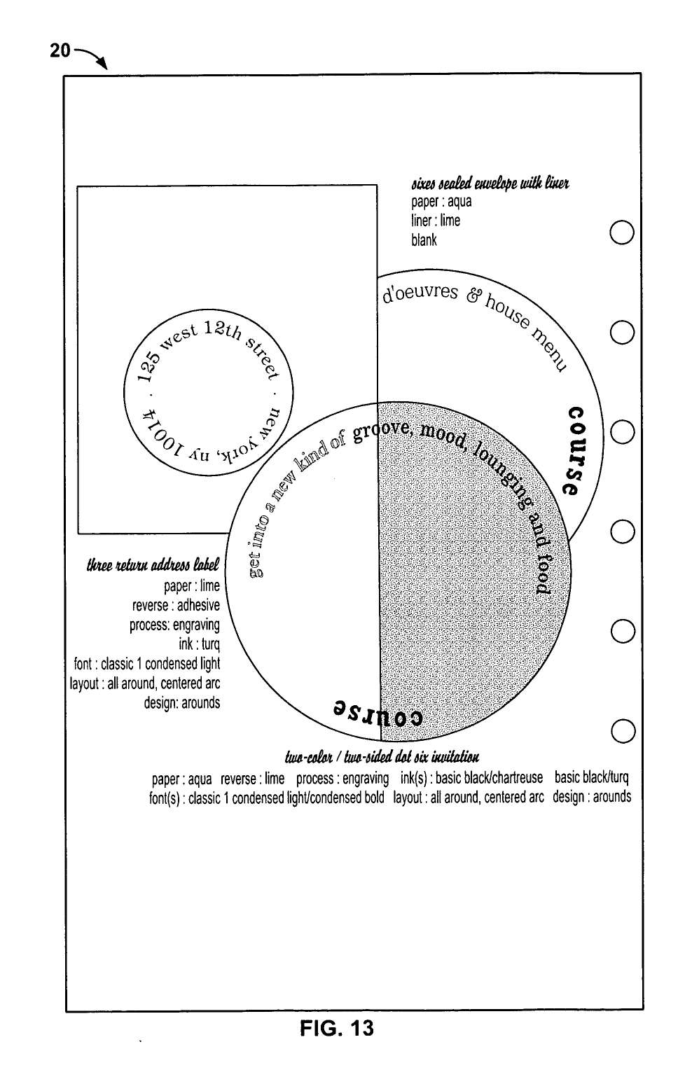

Referring to FIG. 13, in addition to the design guide, the system of the present invention also comprises a collection of sample printed article assemblies 20, each of the sample printed article assemblies exemplifying various combinations of the plurality of design options for the plurality of design parameters. The sample printed article assemblies represent complete printed article assemblies that result from the selection of specific design options presented in the design guide and provide a range of different looks available through the selection of different design options. As such, the collection of sample printed article assemblies demonstrates to consumers a variety of designs that are possible when a printed article assembly is designed following the direction of the design guide. The collection can therefore be used as a cross-reference when deciding which specific design options to select from the design guide. Alternatively, the collection of sample printed article assemblies can be used as a starting point in the custom-design process. In other words, the consumer can select a specific design presented in the collection and can then customize certain design parameters by consulting the design guide. The collection of sample printed article assemblies may also demonstrate specific designs that may be ordered “as is” from a retailer. As seen in FIG. 13, preferably each sample printed article assembly provides a description of the specific ones of the plurality of prescribed design options for each of the plurality of design parameters chosen for that sample printed article assembly. This way, the consumer knows exactly what combination of design options gave rise to the displayed sample printed article assembly. In a preferred embodiment, the order in which the design options are described matches the order in which the design options are presented in the design guide.

The collection of sample printed article assemblies may include any combination of design options prescribed in the design guide. Non-limiting examples of sample printed article assemblies presented in the collection are three two-sided/color contrasting invitations and three corresponding sealed envelopes presented in a double full-page layout on facing pages of a binder with a title page on a preceding page. The presentation of designs on facing pages provides the consumer with comparisons for assistance in choosing preferred design parameters.

For example, the first two-sided/color contrasting invitation with sealed envelope can be a two-sided invitation of a prescribed size constructed of lemon-colored paper with a reverse color of aqua, having engraving with turquoise ink in a prescribed font, and a layout of center/center with center justification. This first sample printed article can, for example, be presented along with a sealed envelope of a corresponding size constructed from aqua-colored paper and a liner of lemon-colored paper with engraving in canary-colored ink having a font corresponding to the respective invitation and a layout of lower back center with center justification. Included in the sample printed article assembly can be, for example, a menu constructed of lemon-colored paper, with engraving in turq ink in a matching font and having a layout of center/ center and center justification. An embedded flap program can be additionally presented as part of the sample printed article assembly. The embedded flap program, for example, can be constructed of aqua and lemon paper with engraving in canary ink and corresponding font with a layout of center/center and a center justification with additional embedded flaps (pages) of powder paper, flat printed in turq ink with the same layout and justification. Also a blank escort card constructed of aqua paper with hand calligraphy in a corresponding font and canary ink can be presented. This first sample printed article assembly can also be presented on two facing full pages of a binder with text describing the design options chosen from the design guide that gave rise to the sample printed article assembly. The preceding page of the binder can contain a title for the group of sample printed article assemblies displayed in the subsequent pages of the binder.

The second and third two-sided/color contrasting invitations with sealed envelopes can be, for example, a two-sided invitation of a prescribed size constructed from leather of scarlet and paper of regal, printed using ink of purple and engraved with ruby on the reverse in a prescribed font with a layout of lower center edge/lower center with center justification. This second printed article can be presented along with a sealed envelope of a size corresponding to the size of the invitation and constructed of regal-colored paper, engraved with ink of ruby in a corresponding prescribed font and in a layout of lower back center with center justification. The third example can be a two-sided invitation of a prescribed size constructed from leather of espresso and paper of coffee, printed using ink of gold and flat printed with chocolate on the reverse in a prescribed font with a layout of center/center with center justification. This third printed article can be presented along with a sealed envelope of a size corresponding to the size of the invitation and constructed of coffee-colored paper, flat printed with chocolate ink in a corresponding prescribed font and in a layout of lower back flap center with center justification. These second and third samples can also be presented on two facing full pages of a binder with text describing the design options chosen from the design guide that gave rise to the sample printed article assembly. The preceding page of the binder can contain a title for the group of sample printed article assemblies displayed in the subsequent pages of the binder.

Another non-limiting example of a sample printed article assembly that can be included in the collection of sample printed article assemblies is an invitation with button-tie envelope, color contrasting reply postcard, and triple-folded information and map pamphlet presented as an event suite on double full-facing pages of a binder with a title page on a preceding page. The invitation can be of a prescribed size constructed from coffee-colored paper and printed with flat printing in ruby ink of a prescribed font. The invitation can have a layout of center/center lines between text blocks, fully centered, with center justification. The invitation can be presented together with a button-tie envelope of a corresponding size, constructed of scarlet paper with a liner of solid scarlet, engraved with tan ink in a corresponding font and having a layout of upper back flap center with center justification. Included in the sample printed article assembly can be a reply postcard constructed of coffee paper on one side and a reverse side of scarlet paper, with flat printing in ruby ink in matching font and having a layout of a one-sided reply with return address and left justification. A triple-folded map pamphlet can be additionally presented as part of the sample printed article assembly. The map pamphlet can be constructed of coffee-colored paper with flat printing in ruby ink and corresponding font with a layout of center/center and a center justification. The printed article assembly can be presented on two facing full pages of a binder with text describing the design options chosen from the design guide that gave rise to the sample printed article assembly. The preceding page of the binder can contain a title for the group of sample printed article assemblies displayed in the subsequent pages of the binder.

Another non-limiting example of a sample printed article is a two-color/two-sided, color contrasting invitation with sealed envelope with liner and return address label and two menus presented as an event suite on facing pages of a binder with a title page on the preceding page. The invitation can be presented in the shape of a circle of a prescribed size. It can be constructed from aqua-colored paper, with a reverse side of lime-colored paper, engraved with basic black, chartreuse and turquoise complementing inks. The text can have a prescribed font and a prescribed layout on the edge of the circle in a centered arc. The invitation can be presented along with a sealed envelope of a corresponding size, which can be constructed from aqua-colored paper and can have a lime-colored liner with no text. A return address label can be provided in the shape of a circle and constructed of lime-colored paper with adhesive on the reverse side and engraved in turquoise-colored ink with a prescribed font in a layout of text on the edge of the circle in a centered arc. On the opposing page of the binder, two menus can be presented. The first menu can be a three-page menu, bound together with an eyelet, constructed from lime and aqua papers, engraved with turquoise and chartreuse inks in a prescribed font. The first page of the menu can contain a layout of centered arcs at six and ten o'clock positions. The second and third pages can contain a layout of center/center with center justification. The second menu can be a two-page layout bound together with an eyelet, constructed from lime and aqua paper, engraved in chartreuse and turquoise ink with a font corresponding to the first menu and a first-page layout of centered arcs at 6 and 10 o'clock positions. The second page layout can be center/center with center justification.

Of course, the above-described sample printed article assemblies are only exemplary and illustrate how the collection of sample printed article assemblies can be compiled and presented, although additional or alternative designs for the sample printed article assemblies are within the scope of the present invention. The above-description also provides an example of complete sample printed article assemblies that can be designed by following the preferred sequential sections of the preferred embodiment of the design guide described above. Of course, other designs of complete sample printed article assemblies can also be designed depending on the design options and design parameters presented by a design guide.

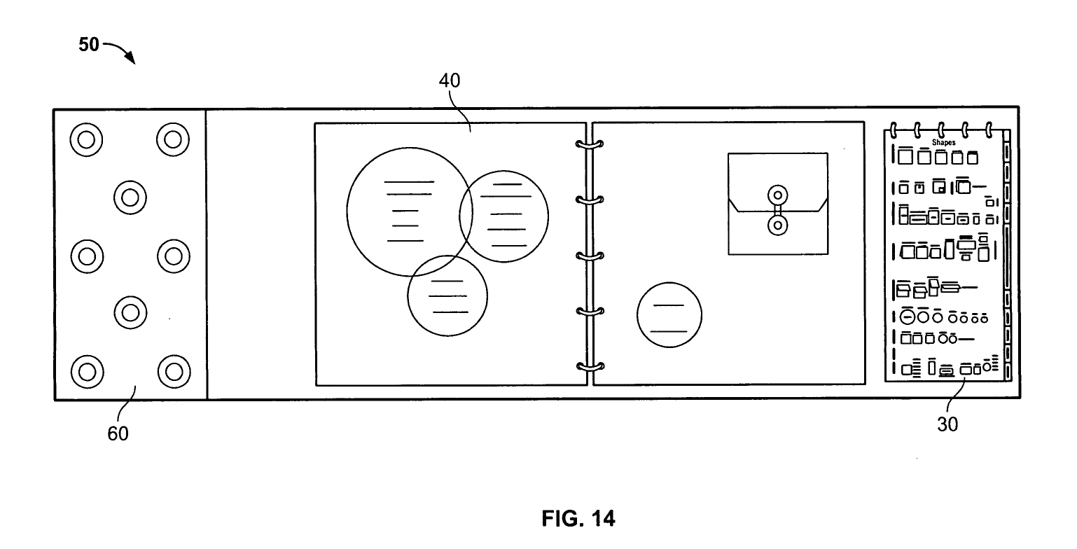

Referring to FIG. 14, in an embodiment, the design guide 30 and collection of sample printed article assemblies 40 of system 50 are assembled together in a binder 60 such that collection 40 can be easily cross-referenced during the custom-designing process as directed by design guide 30. Preferably, the collection of sample printed articles 40 are presented as full-page layouts, flipping on a vertical spine on one side of binder 60 and design guide 30 flips on a separate horizontal spine on the other side of binder 60. Also preferably, each sequential section of design guide 30 is tabbed such that the category of design parameter presented by each sequential section is readily visible and can be easily accessed.

In another embodiment, the system of the present invention further comprises a reference manual that provides additional information to support the design process of the system of the invention. Specifically, the reference manual expounds upon the information contained in the design guide and/or the collection of sample printed article assemblies and provides the consumer with additional directions and considerations with respect to the decision-making process set forth in the design guide. Specifically, the reference manual may provide fully developed details for each design step as presented by each sequential section of the design guide. The reference manual also provides an additional checks-and-balances system to check and balance the design process as the consumer progresses through the design guide and references the collection of sample printed article assemblies.

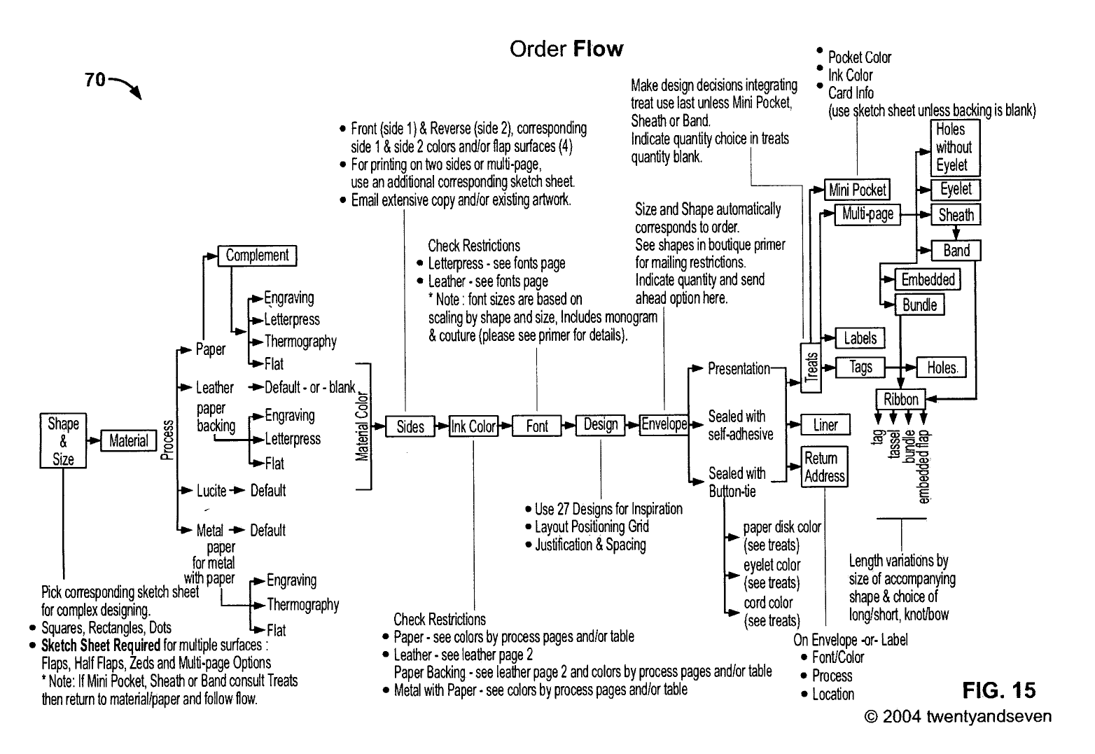

For examples, referring to FIG. 15, the reference manual may include a flow chart 70 sequentially outlining the plurality of design parameters and the specific ones of the plurality of design options available for certain ones of the plurality of design parameters. Such a flow chart provides a quick reference during the ordering process as well as checks-and-balances to ensure no restricted combinations of design options are selected. Preferably the flow chart follows the same sequence of the plurality of design parameters as presented by the design guide to further ease the ordering process.

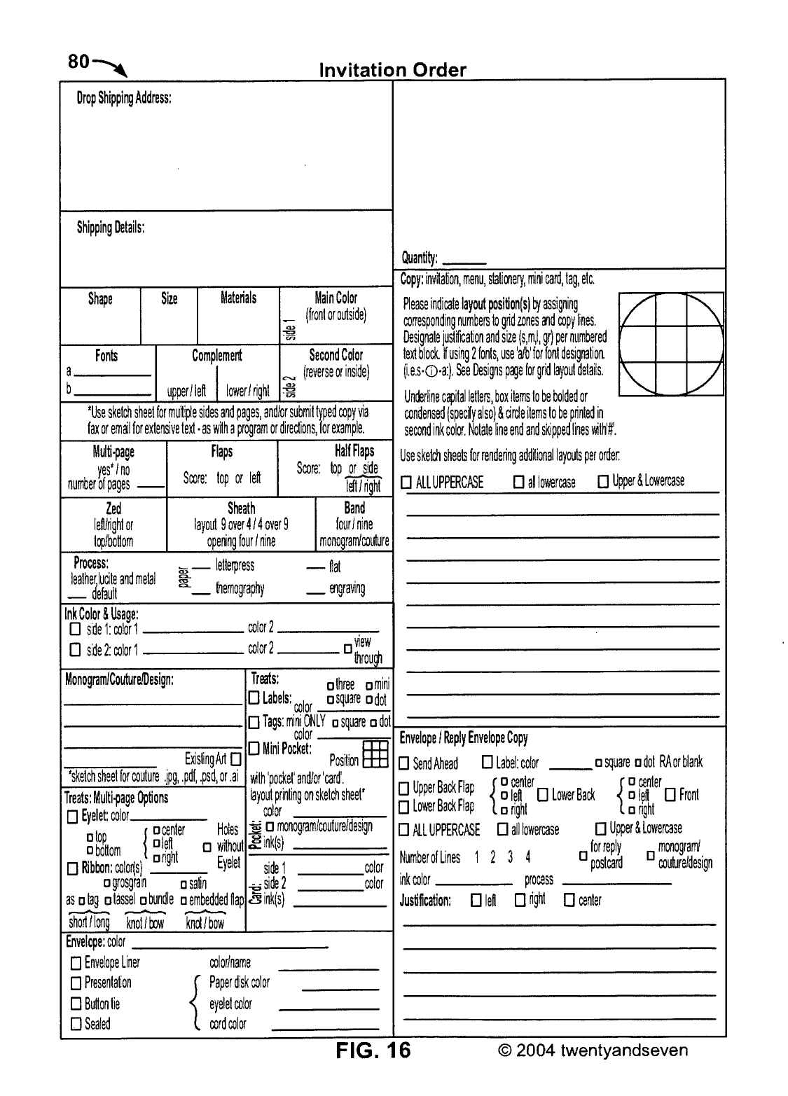

Referring to FIG. 16, the reference manual may additionally include an order form 80, which provides specific details regarding particular design options. The layout of the order form can reflect the progression of design steps contained in the design guide. The order form can provide the consumer with further structure in the decision-making process. Additionally, the order form can reflect the order flow that is contained in the flow chart 70. The order form can also contain layout information such as grids for justification of copy or other illustrations or orientation of design options.

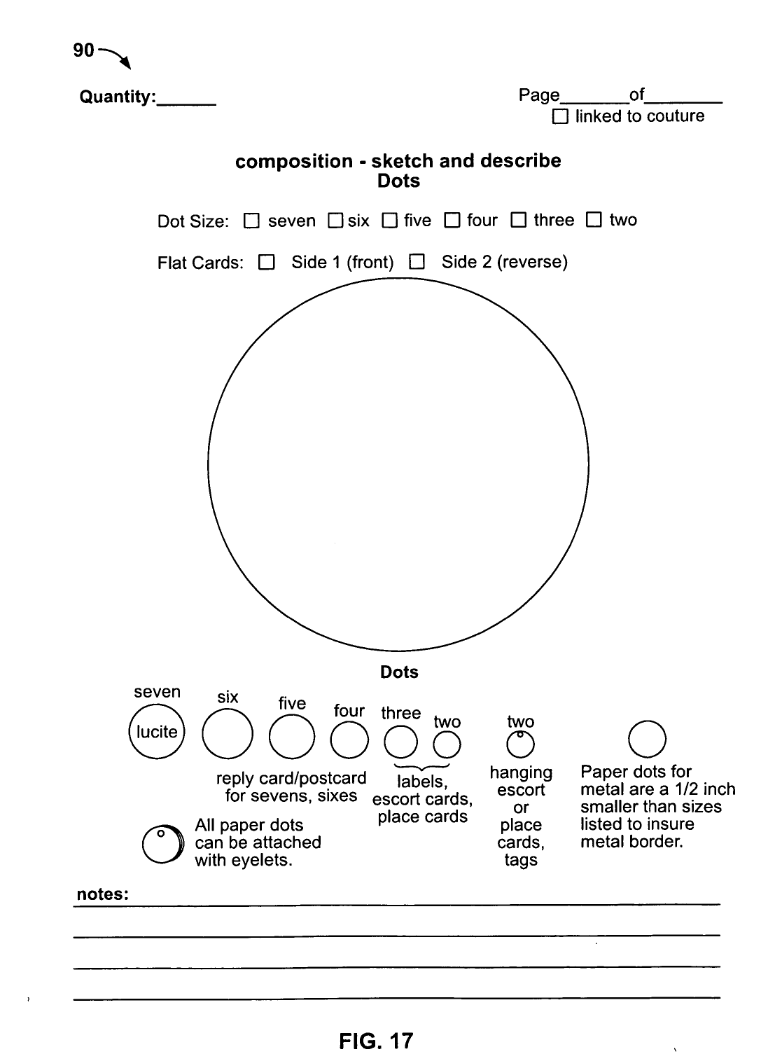

Additionally, referring to FIG. 17, the reference manual can contain sketch sheets 90 that reiterate the potential configurations of the printed article as depicted by the design guide and enable the consumer to sketch out designs for prospective orders when necessary. Sketch or composition sheets can show the consumer additional availabilities by size, shape, orientation and options for mounting of complementary stock. Such sketch or composition sheets may be specific to a particular design step or may be generalized for use throughout the design process. Specific decision steps that are directed or required by the design guide may be printed on the sketch or composition sheets. The sketch or composition sheets may further contain suggestions on specific design steps and general tips on design. The sketch or composition sheets may be directed to particular design options such as shapes, pockets, envelopes, folded sheets, prescribed sizes, binding of printed articles, collation of printed articles, sheathing of printed articles, orientation of printed articles, suggested accompanying components for particular printed articles such as reply cards or thank you notes and positions for optional accessories and treatments including eyelets, drilled holes, cords and ribbons. Further, the reference manual itself may have information on the availability of these parameters in a particular context. The reference manual may further provide guidance to the consumer as to which sketch and composition sheets are appropriate for which stages of the design process.

The reference manual may also contain directions, limitations, restrictions or availabilities with respect to the design process in general. For example, the reference manual may describe methods for printing existing art concepts onto printed article assemblies. Such art may be submitted by the consumer, for example, for inclusion in a particular design. The reference manual may also provide methods for placing copy or symbols or pictures in a particular layout. It may further contain suggestions for grids or other determinations of position. With respect to recommendations, the reference manual may also assist the consumer in considering the entirety of an event for which a printed article is being designed. Specifically, the reference manual may contain information regarding coordinating an event suite. For example, the reference manual may suggest that when coordinating elements in a complement suite, reverse sides may assume one of the complement colors, or, as another example, all similar shapes may assume the same color scheme. The reference manual may also provide suggestions as to use of particular design options for particular events. It may further recommend the use of particular colors from the design guide in coordinating the event suite with other colored articles in an event such as table cloths, flower arrangements and linens.

The reference manual can provide additional information on the results of the possible interactions of stock material, color and ink. Preferably the reference manual can provide a set of representations of available paper colors printed with a variety of available inks. The reference manual can also provide a chart for easy reference that communicates succinctly how each available paper color interacts with each available ink color and additionally provides prohibitions for use of certain color combinations.

The reference manual may also provide additional details including limitations, restrictions and recommendations with respect to specific design parameters or specific design options. For example, with respect to printing processes, the reference manual may provide information on printing processes that are available and colors and stock materials that are available therewith. It may also provide suggestions for use of particular colors and stock materials together and further provide information on how particular processes effect the final presentation of a color or a stock material. It may additionally provide examples of particular process results with sketch sheets and suggestions accompanying said examples. The reference manual may additionally provide information on the matching of different processes on a printed article and the accompanying components of the printed article. With respect to potential configurations of the printed article, the reference manual may provide information and instructions concerning printable surfaces on a particular folded or bundled printable article. Furthermore, the reference manual may provide further information on embedded flap designs, which may require ribbons or some other securing device, or methods for creating sheaths of articles with bands, or ribbons or cords. With respect to available fonts, the reference manual may group fonts in styles to inspire an overall direction of feeling for the design. The size of a font may be scaled in variations of the consumer's preference for small, medium, large, grand, or to scale of the piece. The reference manual may provide suggestions or restrictions as to the use of particular fonts in particular design styles. The reference manual may also restrict fonts for particular printing processes such as letterpress and leather. With respect to potential layouts of the printed article, the reference manual may provide instructions as to acceptable grids for sketches. The reference manual may also provide prescribed layout styles and may give these styles user-friendly names such as “on the edge.” “On the edge” may be a design style wherein copy is placed along the edge of an article.

The reference manual may also contain policies and procedures of the retailer such as order specific details, payment expectations, contact information, proofs, confirmation sheets, packing lists, fax cover sheets, shipment policies, options or requirements for insurance and invoices.

Of course, the above-described reference manual is only exemplary and simply provides an example of the type of information that can be contained in a reference manual to further assist in the design process and further expound upon the information contained in the design guide and collection of sample printed articles, as well as the ordering process. Additional or alternative information may be included in the reference manual according to the present invention. Further any of the above-described components of the reference manual could be a separate part of the system of the present invention, instead of being included in the reference manual.

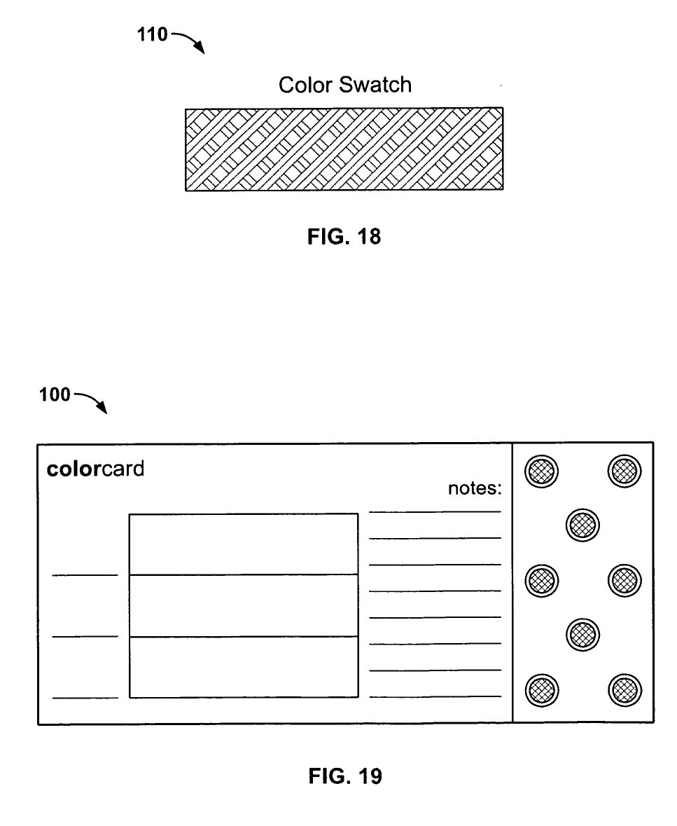

Referring to FIGS. 18 and 19, in order to facilitate incorporation of the printed article assembly in the presentation of a complete event, preferably the system of the present invention further includes a plurality of cards 100 and a plurality of color swatches 110 attachable, preferably by self-adhesion, to the plurality of cards. The color swatches illustrate each of the plurality of colors (for the stock materials and/or the ink) depicted in the design guide. Upon ordering, the consumer can receive a card having any number of color swatches attached thereto that correspond to the colors chosen by the consumer for the printed article assembly, for use in matching other items for the event, such as linens, flowers, and place settings.

The present invention also provides a method of designing a custom printed article assembly. The method comprises sequentially selecting at least one of a plurality of design options for each of a plurality of design parameters. The method further comprises consulting a collection of sample printed article assemblies exemplifying various combinations of the plurality of design options for the plurality of design parameters. The design parameters can be any of the design parameters mentioned above with reference to the system of the present invention. In a preferred embodiment, the method comprises selecting at least one specific configuration option among a plurality of configuration options for the printed article, selecting at least one specific color option among a plurality of color options for the printed article assembly, selecting at least one specific stock material option from which the printed article assembly is manufactured among a plurality of stock material options for the printed article assembly, selecting at least one specific printing process option among a plurality of printing options for the printed article assembly, selecting at least one specific ink color option among a plurality of ink color options for the printed article assembly, selecting at least one specific font option among a plurality of font options for the printed article assembly, and selecting at least one layout option among a plurality of layout options for the printed article, optionally selecting at least one envelope configuration among a plurality of envelope configurations for the enVelope of the printed article assembly, optionally selecting at least one liner option among a plurality of liner options, and optionally selecting at least one accessory option or treatment option among a plurality of accessory and treatment options for the printed article assembly.

The foregoing description and examples have been set forth merely to illustrate the invention and are not intended as being limiting. Specifically, many of the figures depict specific prescribed design options such as specific colors of the stock material from which the printed article assembly is manufactured or specific fonts used to print the characters of the printed articles. Such design options are merely exemplary and are not intended to be exclusive or exhaustive design options. Each of the disclosed aspects and embodiments of the present invention may be considered individually or in combination with other aspects, embodiments, and variations of the invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Furthermore, all references cited herein are incorporated by reference in their entirety.

I claim:

1. A system for designing a custom printed article assembly comprising:
a design guide comprising sequential sections, each of the sequential sections depicting a plurality of prescribed design options for a different one of a plurality of design parameters, the design guide directing the serial selection of at least one of the plurality of prescribed design options for each of the plurality of design parameters for designing a complete custom printed article assembly; and
a collection of sample printed article assemblies, each of the sample printed article assemblies exemplifying various combinations of the plurality of prescribed design options for the plurality of design parameters.

2. The system of claim 1, wherein the plurality of design parameters comprise configuration of the printed article, stock material from which the printed article assembly is manufactured, layout of the printed article, configuration of an envelope in which the printed article is insertable, or any combination thereof.

3. The system of claim 2, wherein the plurality of design parameters further comprise color of the stock material from which the printed article assembly is manufactured, printing process of the printed article assembly, color of ink used to print the characters of the printed article assembly, type of font used to print the characters of the printed article assembly, accessory items accompanying the printed article assembly, treatments modifying the printed article assembly, or any combination thereof.

4. The system of claim 1, wherein the design guide directs the serial selection of at least one of the plurality of prescribed design options for each of the plurality of design parameters in the following order of the plurality of design parameters: configuration of the printed article, color of the stock material from which the printed article assembly is manufactured, stock material from which the printed article assembly is manufactured, printing process of the printed article, color of ink used to print the characters of the printed article assembly, type of font used to print the characters of the printed article assembly, layout of the printed article, configuration of an envelope in which the printed article is insertable, accessory items accompanying the printed article assembly, and treatments modifying the printed article assembly.

5. The system of claim 1, wherein the design guide and the collection of sample printed article assemblies are assembled together in a binder.

6. The system of claim 1, wherein the collection of sample printed article assemblies provides descriptions of the specific ones of the plurality of prescribed design options for each of the plurality of design parameters chosen for each of the sample printed article assemblies.

7. The system of claim 1, further comprising a reference manual providing limitations regarding the combination of certain ones of the plurality of design options with other ones of the plurality of design options.

8. The system of claim 1, wherein the design guide provides limitations regarding the combination of certain ones of the plurality of design options with other ones of the plurality of design options.

9. The system of claim 1, further comprising a flow chart sequentially outlining the plurality of design parameters and the specific ones of the plurality of design options available for certain ones of the plurality of design parameters.

10. The system of claim 1, wherein one of the plurality of design parameters is color and the respective plurality of design options are a plurality of different colors.

11. The system of claim 10, further comprising:
a plurality of cards; and
a plurality of swatches attachable to the plurality of cards, each of the plurality of swatches illustrating one of the plurality of different colors.

12. The system of claim 11, wherein the color swatches are self-adhesive.

13. The system of claim 1, wherein the printed article is a menu, a stationery, a business card, a holiday card, a greeting card, an invitation, or an announcement.

14. A method for designing a custom printed article assembly comprising:
sequentially selecting at least one of a plurality of design options for each of a plurality of design parameters; and
consulting a collection of sample printed article assemblies, each of the sample printed article assemblies exemplifying various combinations of the plurality of prescribed design options for the plurality of design parameters.

15. The method of claim 14, wherein the design parameters comprise configuration of the printed article, color of the stock material from which the printed article assembly is manufactured, stock material from which the printed article assembly is manufactured, printing process of the printed article, color of ink used to print the characters of the printed article assembly, type of font used to print the characters of the printed article assembly, layout of the printed article, configuration of an envelope in which the printed article is insertable, accessory items accompanying the printed article assembly, treatments modifying the printed article assembly, and any combinations thereof.

16. The method of claim 15, wherein sequentially selecting at least one of a plurality of design options for each of a plurality of design parameters comprises:
selecting at least one specific configuration option among the plurality of configurations option for the printed article;
selecting at least one specific color option among the plurality of color options for the printed article;
selecting at least one specific stock material option among the plurality of stock material options for the printed article;
selecting at least one specific printing process option among the plurality of printing process options for the printed article;
selecting at least one specific ink color option among the plurality of ink color options for the printed article;
selecting at least one specific font option among the plurality of font options for the printed article;
selecting at least one layout option among the plurality of layout options for the printed article; and
selecting at least one liner option among the plurality of liner options for the printed articles.

17. The method of claim 16, further comprising selecting at least one accessory option among the plurality of accessory options for the printed article.
